(19) United States
(12) Patent Application Publication
(10) Pub. No.: US 2011/0058807 A1
(43) Pub. Date: Mar. 10, 2011

(54) TRANSMISSION APPARATUS, TRANSMISSION SYSTEM AND FAILURE DETECTION METHOD

(75) Inventors: Rei SUZUKI, Fujisawa (JP); Toshiyuki ATSUMI, Fujisawa (JP); Koji TAKATORI, Tokyo (JP); Kazutaka SAKAI, Yamato (JP)

(73) Assignee: HITACHI, LTD., Tokyo (JP)

(21) Appl. No.: 12/796,927

(22) Filed: Jun. 9, 2010

(30) Foreign Application Priority Data
Jun. 23, 2009 (JP) 2009-148240

(51) Int. Cl. H04B 10/08

(52) U.S. Cl. 398/23

(57) ABSTRACT

To detect a transmission path cut-off or deterioration depending on the presence or absence of receiving a packet signal at a fixed time interval without transferring an OAM packet. At a transmitting side, a conversion section periodically sends a main signal without including a maintenance operation signal packet. At a receiving side, a transmission path failure detection device judges that a transmission path failure is detected if it is determined that the next main signal is not received for a preset time after receiving the main signal. An OAM processing section detects a state where the main signal is not transmitted to the opposed transmission apparatus or an idle state, based on the detection of the transmission path failure by the transmission path failure detection device, and sends a maintenance operation signal for notifying the transmission path failure to the opposed transmission apparatus when in the idle state.

### CLAIM OF PRIORITY

The present application claims priority from Japanese patent application JP 2009-148240 filed on Jun. 23, 2009, the content of which is hereby incorporated by reference into this application.

### BACKGROUND OF THE INVENTION

1. Field of the Invention

The present invention relates to a transmission apparatus, a transmission system and a failure detection method, and more particularly to a transmission apparatus, a transmission system and a failure detection method for detecting a transmission path cut-off using a main signal packet in the MPLS technology such as a T-MPLS.

Further, the invention relates to a method for detecting a transmission path cut-off using a main signal packet, instead of a maintenance signal to detect the transmission path cut-off by periodically transmitting amain signal packet, in a transmission apparatus in which a synchronous transmission signal such as an SDH (Synchronous Digital Hierarchy)/SONET (Synchronous Optical NETwork) signal as defined in an ITU-T (International Telecommunication Union Telecommunication Standardization Sector) Y.1370. 1, Y.1371, Y.1381) is encapsulated or decapsulated in an MPLS (Multi-Protocol Label Switching) signal.

2. Description of the Related Art

In recent years, a backbone network of a communication carrier has progressed toward the full Internet Protocol (IP)/Ethernet (registered trademark), and become in a situation where an old backbone network based on the SDH/SONET technology existent from times past and a new backbone network based on the IP/Ethernet technology coexist.

In this situation, to resolve the inefficiency in the installation and maintenance due to the coexistent networks, a review for integrating them into the backbone network based on the IP/Ethernet has been made by constructing an SDH/SONET signal into an IP/Ethernet packet. Such a review technology is specifically represented by a T-MPLS (Transport-MPLS) technology as defined in the ITU-T Y.1370.1, Y.1371, Y.1381.

FIG. 1 shows an MPLS data frame format.

In the T-MPLS technology, an SDH/SONET signal has a payload part consolidated in the integral multiple of bytes of a basic unit of frame with a low order group path as the basic unit of frame in accordance with the ITU-T Y.1413 (TDM-MPLS (Time Division Multiplexing-MPLS) inter-working regulations on the user plane), and then is stored in a data format of an MPLS frame as shown in FIG. 1. The MPLS frame has a format in which a header for MPLS called a SIM header of four bytes is inserted between a layer 2 header (preamble/SFD, destination address, source address, Type/Length) and a layer 3 header (header of payload data for the SDH/SONET signal). Two or more SIM headers can be stacked.

FIG. 2 is an explanatory view of the content of each field of the SIM header. Since an Ethernet is employed herein as a transmission medium, it has a format in which a MAC (Media Access Control) header (from preamble to Type/Length) and an FCS (Frame Check Sequence) are added, but the physical transmission medium may not be the Ethernet, in which case a header and a footer according to the transmission medium are added, instead of the MAC header and the footer.

In a T-MPLS network, the information of destination IP address is given to a label stored in the SIM header. Thereafter, forwarding is repeated by seeing only the label, and on arrival at a destination place, the label is removed. Consequently, the course of a label packet forwarded by the MPLS can be dealt with as if it were one path. In the T-MPLS network, by controlling a label table of each node, it is possible to provide an IP network with an explicit route, prevent the packets from becoming intensive in the specific route, and increase the use efficiency of the route.

FIG. 3 is an explanatory view of an MPLS OAM frame format.

In the T-MPLS technology, in the IP/Ethernet packet, to support the stable transfer of data at high quality, a maintenance operation function called an OAM (Operation And Maintenance) function is provided in the ITU-T Y.1730, Y.1731, Y.1710 and Y.1711. An OAM frame has the organization in which an OAM label is one SIM header of the MPLS frame as shown in FIG. 1, and the data part is the OAM payload of 44 bytes, as in an OAM frame format as shown in FIG. 3. The OAM label reserves a label ID=14 for the OAM frame in accordance with the Y.1711 of the ITU-T, for example, in which the values of EXP (Experimental use), S and TTL (Time To Live) are defined as EXP=0, S=1 and TTL=1. The payload is composed of Function Type, LSP (Label Switch Path) Trail Termination, Source Identification (TTSI), BIP (Bit Interleaved Party) and a data area for each OAM frame.

FIG. 4 is an explanatory view of a typical example of the MPLS OAM.

Also, FIG. 5 is an explanatory view of an FDI direction and a BDI direction.

The content of each field is shown below.

(1) Function Type

Field indicating an OAM class. The value of this field is defined in the Y.1711 (see FIG. 4).

(2) LSP TTSI

Composed of an LSR ID and an LSP ID that specify an OAM frame send-out node. In the Y.1711, the LSR ID is defined as an IPv6 address or IPv4 address allocated to the node.

(3) BIP16

A BIP16 operation range for error correction is 42 bytes from an OAM function type to immediately before a BIP16 field.

The typical examples of the OAM include a CV (Connectivity Verification), an FDI (Forward Defect Indicator), a BDI (Backward Defect Indicator) and an FFD (First Failure Detection).

A CV is a function of confirming the normality of End to End in a MPLS path, in which the CV is inserted from a UNI (User Network Interface) within an MPLS apparatus at a sending end point, and terminated at the UNI within the MPLS apparatus at a receiving end point. For example, a CV insertion period is fixed at one second, and in the UNI at the CV receiving end point, if a CV non-received state continues for three seconds or more, an LOCV (Loss Of CV) state is detected, and the LOCV detection is notified with a BDI to the UNI at the CV sending end point. With the LOCV detection, it is possible to confirm the state of a transmission path such as a transmission path cut-off.

A FDI is a function of notifying the abnormality and its cause in the upward direction (sending direction) as shown in FIG. 5, in which the FDI is inserted into a detection path at the time of detecting a link cut-off with the user device in the UNI or detecting a link cut-off between the MPLS apparatuses in a NNI (Network Node Interface). For example, the FDI is inserted at an interval of one second until the failure detection is canceled, and notifies the failure information of its factor to the UNI at the termination point of the path and the NNI at the relay point of the path in a Defect type field (e.g., corresponding to the data area for each OAM in FIG. 3) of the payload.

A BDI is a function of notifying the abnormality and its cause in the downward direction (opposite direction of the sending direction) as shown in FIG. 5, in which the BDI is inserted to notify the failure occurrence information to the UNI at an END point in the path where the FDI is received or the LOCV is detected. The BDI is inserted at an interval of one second while the FDI is being received, for example, and notifies the failure occurrence information to the UNI at the termination point of the opposed path and the NNI at the relay point of the path in the Defect type field of the same payload as the FDI.

A FFD is a function of confirming the normality of End to End in the MPLS path, like the CV, in which the FFD is inserted from the UNI at the sending end point and terminated in the UNI at the receiving end point. For example, the insertion period of the CV is fixed at one second, while the insertion period of the FFD can be variably set at 10 ms, 20 ms, 50 ms, 100 ms, 200 ms and 500 ms. The FFD is employed to switch an operating system to a stand-by system, especially when a transmission path cut-off occurs, whereby it is required that the insertion period is changed depending on a permissible switching time, unlike the CV.

Among these OAM signals, the CV and the FFD are transmitted to the opposed apparatus on a path basis at every fixed time to detect a failure on the transmission path by monitoring the CD and the FFD in the opposed apparatus. However, from the viewpoint of the band of transmission path for the CV and the FFD, by increasing the number of paths and shortening the insertion period, there is a possibility that the band of CV and FFD is increased and the band of the main signal packet is correspondingly pressed.

### SUMMARY OF THE INVENTION

In the network using the T-MPLS technology, the transmission path cut-off or deterioration is detected by transferring a specific OAM frame (e.g., CV) at a fixed period. If it is required to shorten the period of quality check (e.g., when the FFD is employed), or if there is a great number of packets for the main signal, the OAM frame band may press the main signal band.

In a T-MPLS signal in which the SDH/SONET signal is encapsulated, the T-MPLS signal is always transferred at a fixed period, unlike the Ethernet signal.

In the light of the above-mentioned problems, an object of the invention is to detect a transmission path cut-off or deterioration depending on the presence or absence of receiving a packet signal at a fixed time interval without transferring an OAM packet.

According to the first solving means of this invention, there is provided a transmission apparatus for performing a process of inserting and receiving a maintenance operation signal by encapsulating an SDH (Synchronous Digital Hierarchy)/SONET (Synchronous Optical NETwork) signal or another synchronous transmission signal in an MPLS (Multi-Protocol Label Switching) signal, and decapsulating the MPSL signal in the SDH/SONET signal, the transmission apparatus comprising:

a transmission path failure detection device that detects a transmission path failure by separating the MPLS signal inputted from an opposed transmission apparatus side into a main signal and a maintenance operation signal;

a maintenance operation signal processing section that sends the maintenance operation signal to the opposed transmission apparatus, based on the detection of the transmission path failure by the transmission path failure detection device; and

a conversion section that encapsulates the SDH/SONET signal or another synchronous transmission signal output from a user device side to be outputted to the opposed transmission apparatus side, and decapsulates the main signal of the MPLS signal output from the transmission path failure detection device to be sent out to the user device side;

wherein the transmission apparatus detects the transmission path failure using the main signal in such a way that:

at a transmitting side,

the conversion section periodically sends the main signal without including a maintenance operation signal packet; and

at a receiving side,

the transmission path failure detection device judges that the transmission path failure is detected if it is determined that the next main signal is not received for a preset time after receiving the main signal; and

the maintenance operation signal processing section detects a state where the main signal is not transmitted to an opposed transmission apparatus or an idle state, based on the detection of the transmission path failure by the transmission path failure detection device, and sends the maintenance operation signal for notifying the transmission path failure to the opposed transmission apparatus when in the idle state.

According to the second solving means of this invention, there is provided a transmission system comprising:

a transmission apparatus above-mentioned,

a network node interface that transmits a multiplexed MPLS signal to an opposed transmission apparatus; and

a switch that switches a transmission path between the transmission apparatus and the network node interface.

According to the third solving means of this invention, there is provided a failure detection method by a transmission apparatus for performing a process of inserting and receiving a maintenance operation signal by encapsulating an SDH (Synchronous Digital Hierarchy)/SONET (Synchronous Optical NETwork) signal or another synchronous transmission signal in an MPLS (Multi-Protocol Label Switching) signal, and decapsulating the MPSL signal in the SDH/SONET signal, the failure detecting method for detecting the transmission path failure using the main signal comprising steps of:

at a transmitting side,

encapsulating the SDH/SONET signal or another synchronous transmission signal output from a user device side, and periodically sending the main signal without including a maintenance operation signal packet, to the opposed transmission apparatus side; and

at a receiving side,

separating the MPLS signal inputted from an opposed transmission apparatus side into a main signal and a maintenance operation signal, and judging that the transmission path failure is detected if it is determined that the next main signal is not received for a preset time after receiving the main signal; and

detecting a state where the main signal is not transmitted to an opposed transmission apparatus or an idle state, based on the detection of the transmission path failure, and sending the maintenance operation signal for notifying the transmission path failure to the opposed transmission apparatus when in the idle state.

With the invention, the OAM packet (e.g., CV, FFD) for detecting the transmission path cut-off is not transferred, whereby the corresponding band can be assigned to the band of main signal, and the transmission capacity can be increased.

### BRIEF DESCRIPTION OF THE DRAWINGS

FIG. 1 shows an MPLS data frame format.

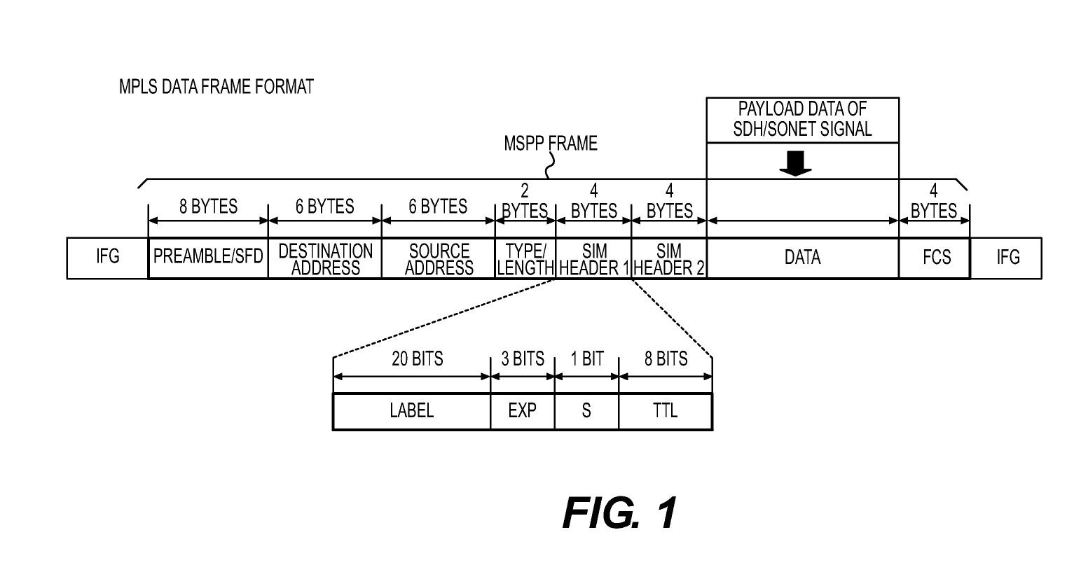

FIG. 2 is an explanatory view of the contents of an SIM header inserted into an MPLS data frame.

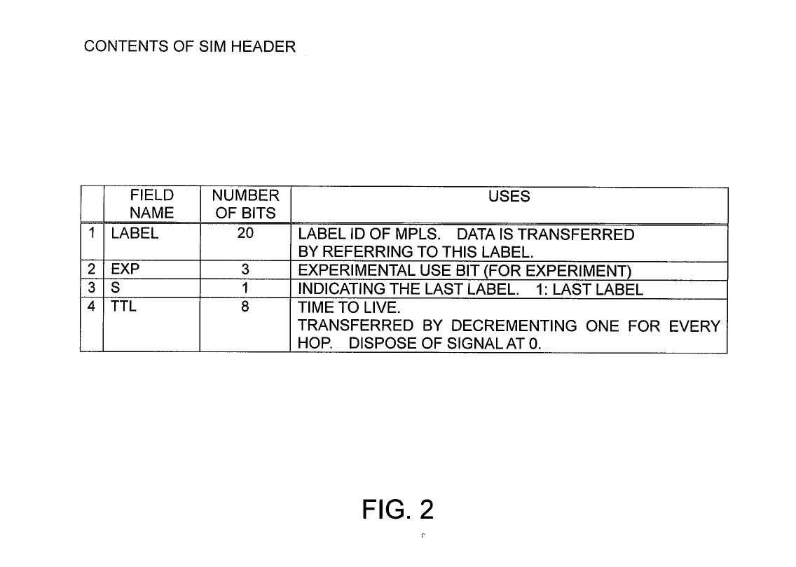

FIG. 3 is an explanatory view of an MPLS OAM frame format.

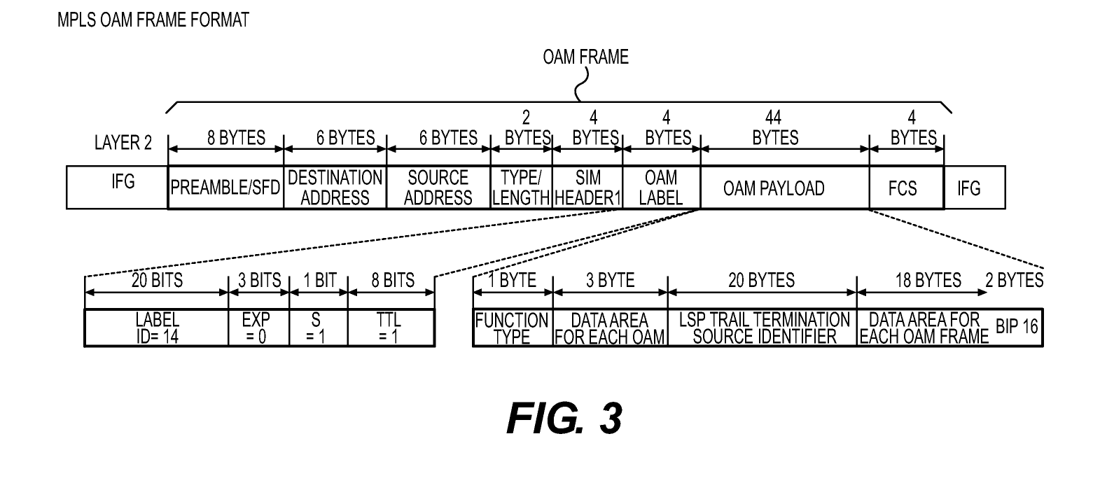

FIG. 4 is an explanatory view of a typical example of the MPLS OAM.

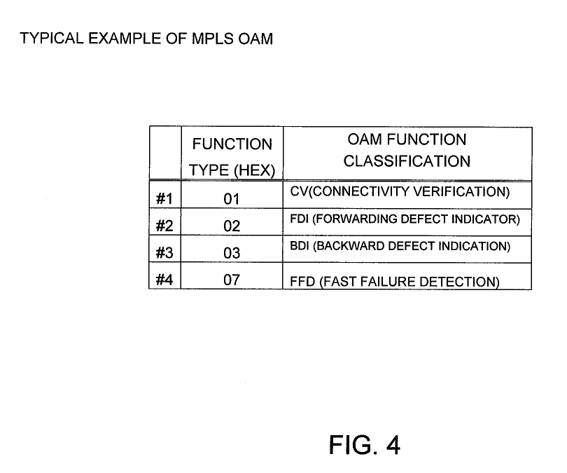

FIG. 5 is an explanatory view of an FDI direction and a BDI direction.

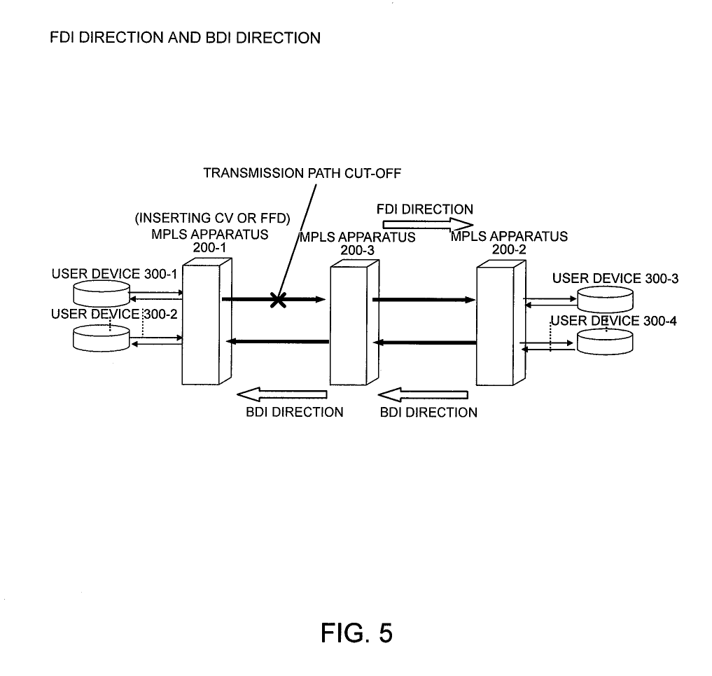

FIG. 6 is a configuration diagram of a network using an MPLS apparatus.

FIG. 7 is a hardware configuration view of the MPLS apparatus.

FIG. 8 is a hardware configuration view of an SDH-UNI board.

FIG. 9 is a flowchart showing a receiving process of FDI•BDI.

FIG. 10 is a flowchart showing a sending process of FDI•BDI.

FIG. 11 is a functional block diagram of a transmission path cut-off detection device.

FIG. 12 is a flowchart of a packet cycle monitoring process.

FIG. 13 shows the comparison between the MPLS signals.

### DETAILED DESCRIPTION OF THE PREFERRED EMBODIMENTS

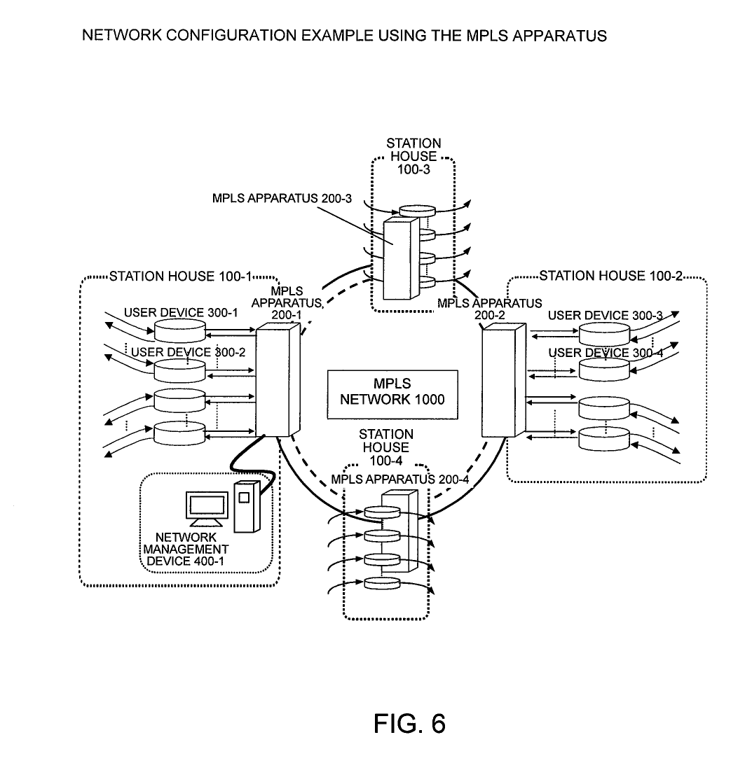

FIG. 6 shows one example of a configuration diagram of a T-MPLS network system according to an embodiment of the invention.

The station houses 100-1 to 100-4 are connected through a main signal transmission path (solid line) by each MPLS apparatus 200-1 to 200-4, in which the MPLS apparatuses 200-1 to 200-4 make up a ring MPLS network 1000. Within a station house 100-1, the user devices 300-1 to 300-2 inputs the signals such as an SDH/SONET signal or Ethernet signal into an MPLS apparatus 200-1. In the MPLS apparatus 200-1, the signals in different formats are encapsulated into the MPLS signal, and transmitted to the opposed MPLS apparatus (e.g., MPLS apparatus 200-2). In the MPLS apparatus 200-2 of transmission destination, the SDH/SONET signal or Ethernet signal is decapsulated from the MPLS signal, and distributed to each user device. Also, the MPLS apparatuses 200-1 to 200-2 are interconnected via a different control line (broken line) from the main signal transmission path, and the states of each MPLS apparatus 200-1 to 200-2 and the main signal transmission path within the MPLS network 100 are managed by a network management device 400-1 connected to the MPLS apparatus 200-1. The network management device 400-1 communicates with each MPLS apparatus 200-1 to 200-4 within the MPLS network 1000 and manages the OAM information including a transmission path failure such as a transmission path cut-off of each of the MPLS apparatuses 200-1 to 200-4. The network management device 400-1 can manage and operate each MPLS apparatus 200-1 to 200-4 by making the centralized control for the transmission path failure that occurs between each MPLS apparatus 200-1 to 200-4 within the MPLS network 1000 at a remote site or in a maintenance center.

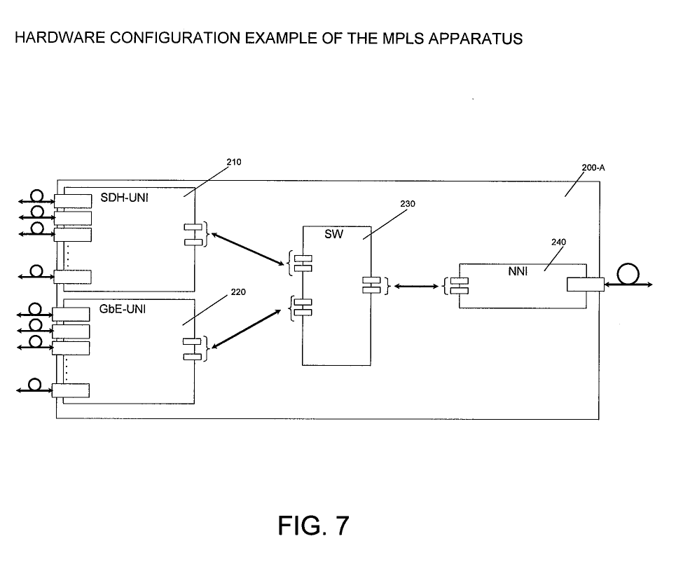

FIG. 7 shows one example of a hardware configuration view of the MPLS apparatus. The MPLS apparatus comprises an SDH-UNI 210, a GbE-UNI 220, a SW (Switch) 230, and an NNI 240. The SDH-UNI 210 makes the encapsulation/decapsulation of the SONET/SDH signal and the MPLS signal, and the multiplexing/demultiplexing. The GbE-UNI 220 makes the encapsulation/decapsulation of the Ethernet signal and the MPLS signal, and the multiplexing/demultiplexing. The SW 230 switches the transmission path. The NNI 240 transmits a multiplexed, high speed signal to the opposed transmission apparatus over a ling distance. Herein, an OAM signal of maintenance operation signal is treated through an insertion and receiving process in the SDH-UNI 210 and the GbE-UNI 220.

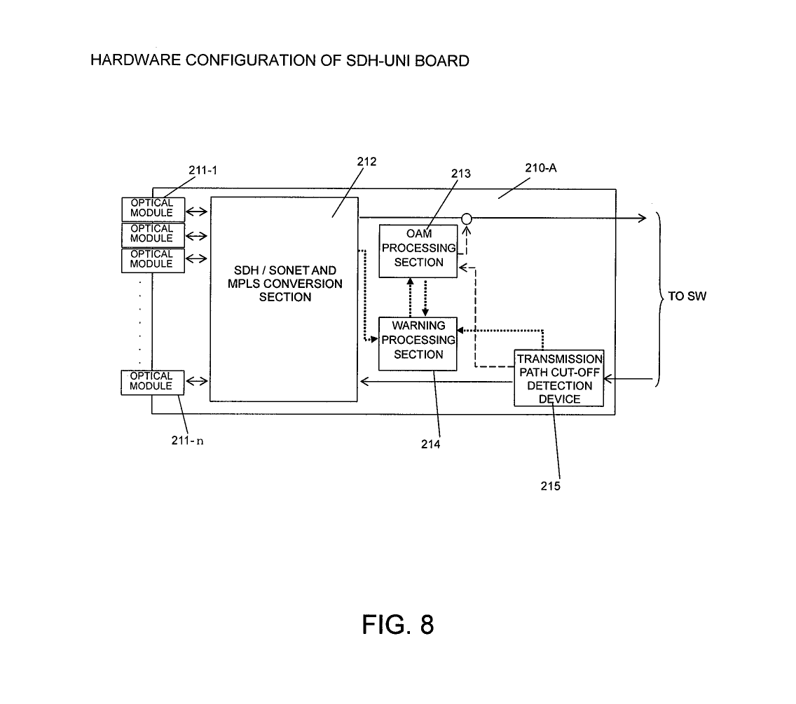

FIG. 8 shows one example of a hardware configuration view of the SDH-UNI 210. First of all, the operation of a main signal (solid line) will be described below. An SDH/SONET signal output from the user device 100 is subjected to a photoelectric conversion in an optical module 211, encapsulated by an SDH/SONET and MPLS conversion section 212, and output to the SW 230. Conversely, the MPLS signal input from the SW 230 is distinguished between the main signal and the OAM signal by a transmission path cut-off detection device 215, and in the case of the main signal, decapsulated by the SDH/SONET and MPLS conversion section 212, subjected to the photoelectric conversion by the optical module 211, and sent out to the user device 100.

Next, the operation of the OAM signal (broken line) will be described below. The OAM signal is sent or received in an OAM processing section 213.

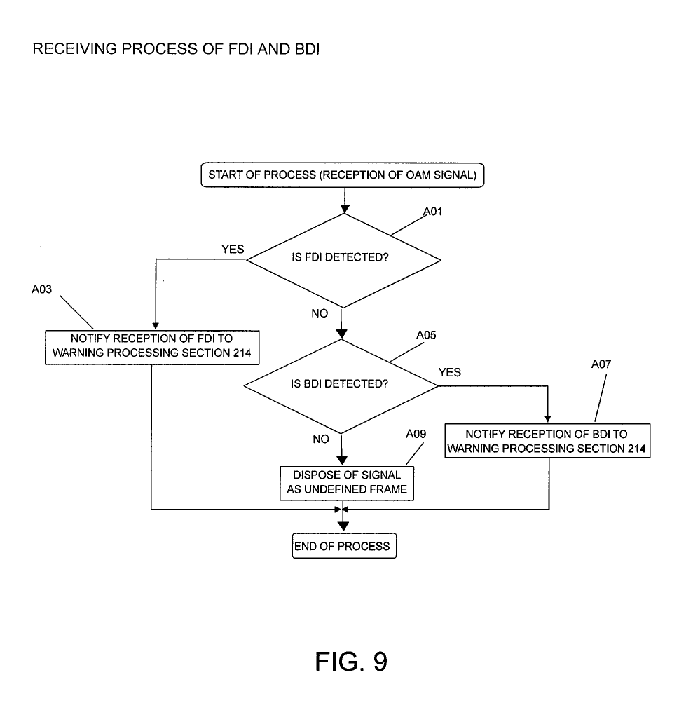

FIG. 9 shows a flowchart of a receiving process of FDI and BDI. In the receiving process, the OAM processing section 213 detects a classification of OAM signal with Function Type as the key (A01, A05), and notifies the classification via a control line (dotted line) to a warning processing section 214 (A03, A07). On this occasion, the OAM processing section 213 disposes of the OAM signal without Function Type defined as an undefined frame (A09). In this way, the OAM processing section 213 makes a notification of FDI reception at step A03, or makes a notification of BDI reception at step A07.

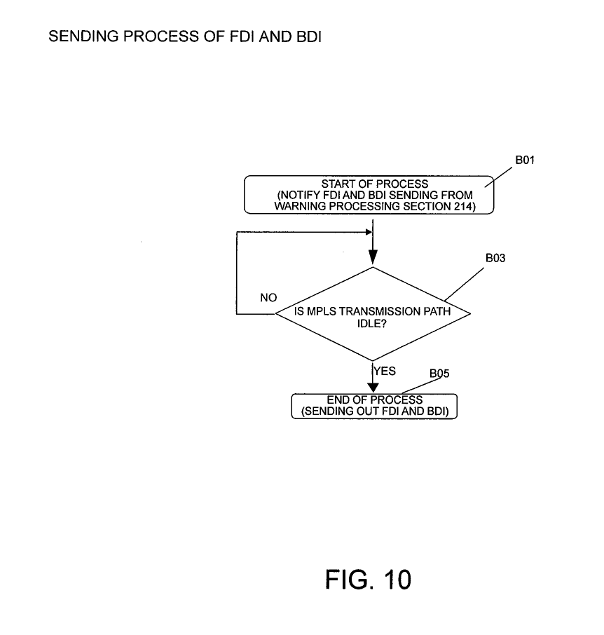

FIG. 10 shows a flowchart of a sending process of FDI and BDI. In the sending process, the SDH/SONET and MPLS conversion section 212 and/or the transmission path cut-off detection section 215 notify a failure to the warning processing section 214, if the failure is detected. For the warning to be notified to the opposed apparatus in case of a transmission path failure such as a transmission path cut-off notified from the transmission path cut-off detection device 215, or reception of the FDI or BDI from the OAM processing section 213, for example depending on the kind of failure, the warning processing section 214 makes a notification of transmitting the OAM signal to the OAM processing section 213, and the OAM processing section 213 receives the notification (B01). On this occasion, the OAM processing section 213 investigates the state of the MPLS transmission path, and determines a packet sending state or an idle state (B03). In the packet sending state, it waits until the packet is transmitted. In the idle state, the OAM signal of FDI or BDI is sent out (B05).

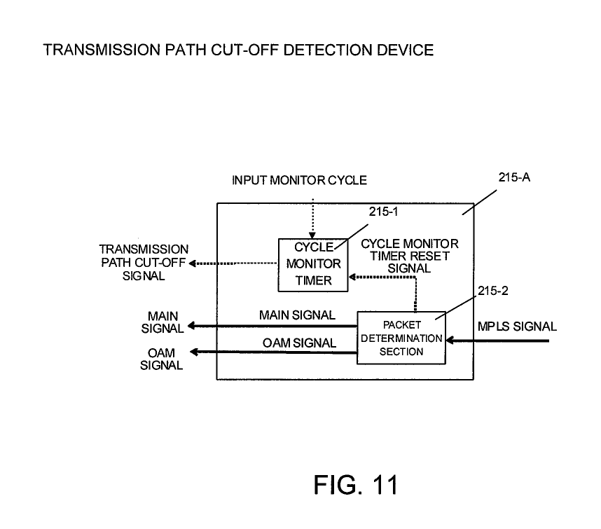

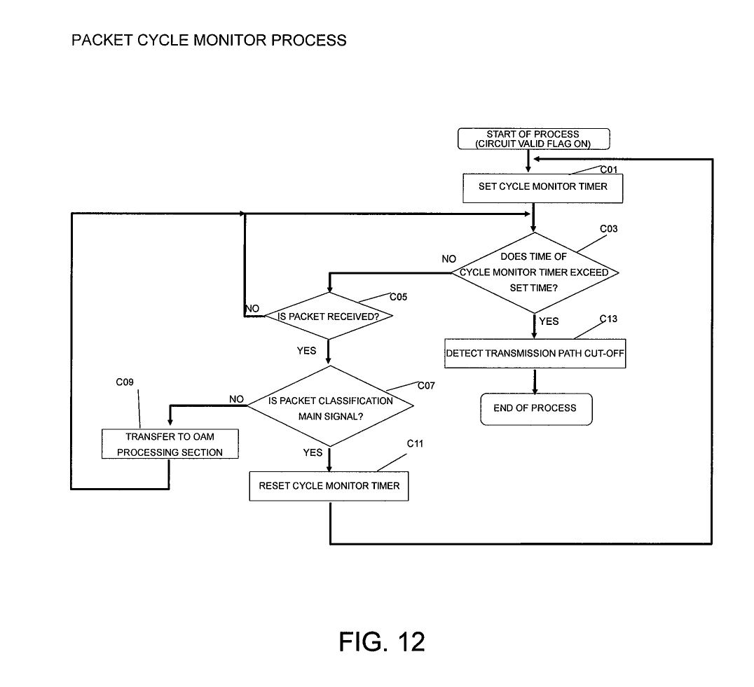

FIG. 11 is a functional block diagram of a transmission path cut-off detection method using a main signal packet. FIG. 12 is a flowchart of a packet cycle monitoring process.

First of all, a packet determination section 215-2 of the transmission path cut-off detection device 215 starts to detect the transmission path cut-off by setting a valid flag. If the valid flag is not set, the packet determination section 215-2 only discriminates the MPLS signal. The packet determination section 215-2 sets a cycle monitor timer 215-1 by setting the valid flag (C01). Thereafter, the packet determination section 215-2 determines whether or not the measured time by a counter of the cycle monitor timer 215-1 exceeds a set time by an external input (C03). If the measured time is within the set time, the packet determination section 215-2 checks the reception of packet (C05). If the packet is not received, the packet determination section 215-2 determines again whether or not the measured time by the counter of the cycle monitor timer 215-1 exceeds the set time by the external input (C03). If the packet is received, the packet determination section 215-2 determines the main signal or OAM signal (C07). In the case of the OAM signal, the packet determination section 215-2 transfers the OAM signal to the OAM processing section 213 (C09), and returns to the time determination (C03). In the case of the main signal, the packet determination section 215-2 resets the counter of the cycle monitor timer 215-1 (C11), and goes to step C01. If the set time is exceeded, the packet determination section 215-2 notifies the transmission path cut-off to the warning processing section 214 (C13). In this way, the transmission path cut-off detection device 215 realizes the transmission path cut-off detection using the main signal packet.

The warning processing section 214, upon receiving the notification of transmission path cut-off, notifies the transmission of the OAM signal to the OAM processing section 213 for FDI in the upward direction (sending direction) of the opposed apparatus or BDI in the downward direction (opposite direction of the sending direction). The OAM processing section 213 performs a sending process upon this notification, as shown in FIG. 10.

Herein, the merits of this method for detecting the transmission path cut-off using the main signal packet will be described below.

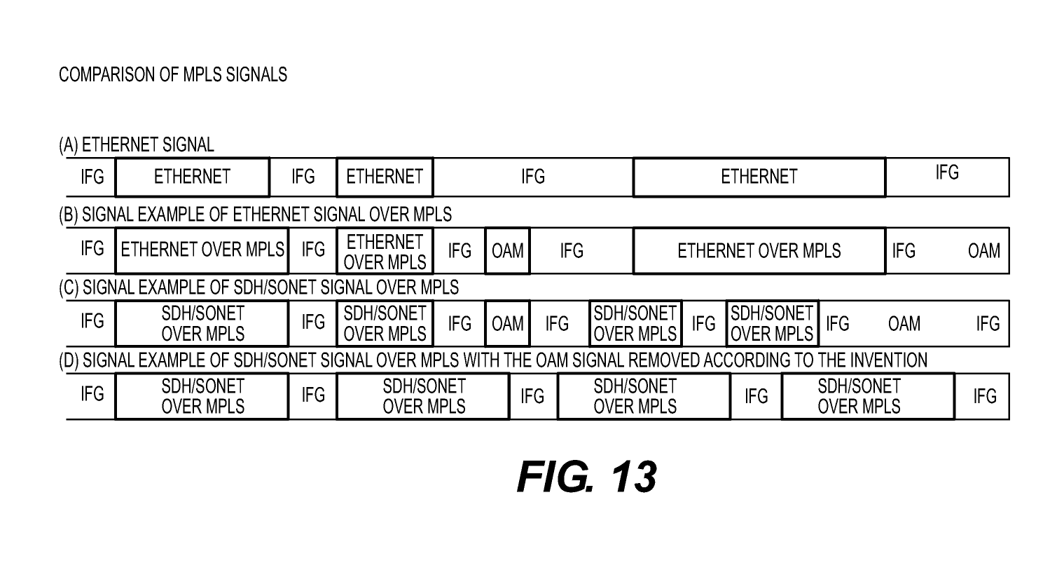

FIG. 13 shows a typical view of the packet sequences of a conventional method and this method. FIG. 13-A shows the Ethernet signal, FIG. 13-B shows the Ethernet signal over the MPLS, FIG. 13-C shows the SDH/SONET signal (conventional method) over the MPLS, and FIG. 13-D shows the SDH/SONET signal (this method).

The Ethernet signal is a burst signal, as shown in FIG. 13-A, and only when there is the signal to be sent, the signal is sent out to the transmission path. Therefore, though the band of the transmission path can be used widely, it is unknown on the receiving side whether the signal is not sent out or the failure occurs on the way, even when a transmission path cut-off occurs, whereby there was a problem on the maintenance and operation that the transmission path cut-off could not be detected. Therefore, the maintenance and operation capability is enhanced by allocating a band to the OAM signal, as shown in FIG. 13-B. On the contrary, the SDH/SONET signal is a stream signal, and the signal is always sent out at a constant frame period. Therefore, when the main signal is interrupted, the failure occurs on the way in any case. Therefore, it is considered that the signal for detecting the transmission path cut-off such as CV and/or FFD of the OAM signal is essentially unnecessary. Thus, with this method, if the main signal is provided with the function of CV or FFD as shown in FIG. 13D, the wider band can be allocated to the main signal. Also, with this method, when the OAM signal such as FDI or BDI is sent, the use of the OAM signal is required, as shown in FIG. 13-C. However, the FDI or BDI is the signal sent only when the abnormality such as LOCV or link cut-off occurs, in which case the communication is not normally performed, and it is unnecessary that the band is allocated to the main signal, whereby the band of FDI or BDI does not press the main signal band during the normal communication.

The invention is applicable to the networks using the T-MPLS technology and other MPLS technologies, or various kinds of networks for detecting the transmission path cut-off or deterioration by transferring the main signal frame at the fixed period.

Also, though the transmission path cut-off has been described above, the invention is not limited to this, but may be applied to various transmission path failures such as deterioration in the transmission path of packet or data.

What is claimed is:

1. A transmission apparatus for performing a process of inserting and receiving a maintenance operation signal by encapsulating an SDH (Synchronous Digital Hierarchy)/SONET (Synchronous Optical NETwork) signal or another synchronous transmission signal in an MPLS (Multi-Protocol Label Switching) signal, and decapsulating the MPSL signal in the SDH/SONET signal, the transmission apparatus comprising:
a transmission path failure detection device that detects a transmission path failure by separating the MPLS signal inputted from an opposed transmission apparatus side into amain signal and a maintenance operation signal;
a maintenance operation signal processing section that sends the maintenance operation signal to the opposed transmission apparatus, based on the detection of the transmission path failure by the transmission path failure detection device; and
a conversion section that encapsulates the SDH/SONET signal or another synchronous transmission signal output from a user device side to be outputted to the opposed transmission apparatus side, and decapsulates the main signal of the MPLS signal output from the transmission path failure detection device to be sent out to the user device side;
wherein the transmission apparatus detects the transmission path failure using the main signal in such a way that:
at a transmitting side,
the conversion section periodically sends the main signal without including a maintenance operation signal packet; and
at a receiving side,
the transmission path failure detection device judges that the transmission path failure is detected if it is determined that the next main signal is not received for a preset time after receiving the main signal; and
the maintenance operation signal processing section detects a state where the main signal is not transmitted to an opposed transmission apparatus or an idle state, based on the detection of the transmission path failure by the transmission path failure detection device, and sends the maintenance operation signal for notifying the transmission path failure to the opposed transmission apparatus when in the idle state.

2. The transmission apparatus according to claim 1, further comprising: a warning processing section that instructs the maintenance operation signal processing section to send the maintenance operation signal by accepting a notification of failure detection from the conversion section, the maintenance operation signal processing section or the transmission path failure detection device.

3. The transmission apparatus according to claim 2, wherein
the transmission path failure detection device notifies the warning processing section if the transmission path failure is detected, and
the warning processing section instructs the maintenance operation signal processing section to send the maintenance operation signal for notifying the transmission path failure to an opposed apparatus.

4. The transmission apparatus according to claim 2, wherein
the maintenance operation signal processing section detects a classification of maintenance operation signal and notifies the detected classification to the warning processing section, if the maintenance operation signal is input from the transmission path failure detection device, and
the warning processing section instructs the maintenance operation signal processing section to send the maintenance operation signal notifying a failure corresponding to the detected maintenance operation signal to an opposed apparatus regarding the warning to be notified to the opposed apparatus.

5. The transmission apparatus according to claim 2, wherein
the conversion section notifies the warning processing section if a failure is detected, and
the warning processing section instructs the maintenance operation signal processing section to send the maintenance operation signal notifying a failure corresponding to the detected maintenance operation signal to an opposed apparatus regarding the warning to be notified to the opposed apparatus.

6. The transmission apparatus according to claim 1, wherein
the transmission path failure detection device comprises:
a determination section that receives an MPLS signal, reads a label of the received MPLS signal, separates the MPLS signal into a main signal and a maintenance operation signal, outputs the main signal to the conversion section, and outputs the maintenance operation signal to the maintenance operation signal processing section, and
a cycle monitor timer that monitors that the main signal is periodically received,
in which the determination section detects a transmission path failure if the main signal is not received for a certain time or more by referring to the cycle monitor timer.

7. The transmission apparatus according to claim 1, wherein the maintenance operation signal is a signal for notifying the abnormality and the failure information of its cause in an upward direction or sending direction, and/or, a signal for notifying the abnormality and either or both of its cause and the failure occurrence information in a downward direction or an opposite direction of the sending direction.

8. A transmission system comprising:
a transmission apparatus according to claim 1;
a network node interface that transmits a multiplexed MPLS signal to an opposed transmission apparatus; and
a switch that switches a transmission path between the transmission apparatus and the network node interface.

9. A transmission system for managing and operating a plurality of transmission apparatuses according to claim 1 in a network having the plurality of transmission apparatuses, the transmission system comprising:
a management device that manages maintenance information including a transmission path failure of the transmission apparatus by communicating with the plurality of transmission apparatuses within the network,
wherein the management device detects the transmission path failure between the transmission apparatuses within the network.

10. A failure detection method by a transmission apparatus for performing a process of inserting and receiving a maintenance operation signal by encapsulating an SDH (Synchronous Digital Hierarchy)/SONET (Synchronous Optical NETwork) signal or another synchronous transmission signal in an MPLS (Multi-Protocol Label Switching) signal, and decapsulating the MPSL signal in the SDH/SONET signal, the failure detecting method for detecting the transmission path failure using the main signal comprising steps of:
at a transmitting side,
encapsulating the SDH/SONET signal or another synchronous transmission signal output from a user device side, and periodically sending the main signal without including a maintenance operation signal packet, to the opposed transmission apparatus side; and
at a receiving side,
separating the MPLS signal inputted from an opposed transmission apparatus side into a main signal and a maintenance operation signal, and judging that the transmission path failure is detected if it is determined that the next main signal is not received for a preset time after receiving the main signal; and
detecting a state where the main signal is not transmitted to an opposed transmission apparatus or an idle state, based on the detection of the transmission path failure, and sending the maintenance operation signal for notifying the transmission path failure to the opposed transmission apparatus when in the idle state.
